(19) United States
(12) Patent Application Publication
(10) Pub. No.: US 2016/0230522 A1
(43) Pub. Date: Aug. 11, 2016

(54) DEEPGAD Bitumen-Heavy Oil Extraction process

(71) Applicant: Noel Daniel, Indianapolis, IN (US)

(72) Inventor: Noel Daniel, Indianapolis, IN (US)

(21) Appl. No.: 14/846,707

(22) Filed: Sep. 4, 2015

Related U.S. Application Data
(60) Provisional application No. 62/048,196, filed on Sep. 9, 2014.

(51) Int. Cl. E21B 43/24; C09K 8/592

(52) U.S. Cl. CPC E21B 43/24; C09K 8/592

(57) ABSTRACT

A process useful in mixing reagents delivered to an injector well which reacts with bitumen-heavy petroleum products in the injector well. The reaction produces significant heat to the bitumen reservoir rock, the heat lowers the viscosity of the material, and permits the flowable material to be collected by a nearby producer well, usually beneath the injector well. The well is assisted with a vacuum system to remove the bitumen containing petroleum materials. This is a method of selectively initiating in situ chemical reaction causing the heating of a targeted subterranean hydrocarbon-bearing formation wherein a substance capable of reacting with hydrogen peroxide is introduced into the formation via an injector well. The resultant mixture of hydrogen peroxide and water is injected to cause an exothermic reaction that increases the temperature of the formation and resident bitumen resulting in a less viscous product with enhanced quality and increased market value.

### CROSS-REFERENCE TO RELATED APPLICATIONS

This application claims the benefit of U.S. Provisional Patent Application with Ser. No. 62/048,196 filed Sep. 9, 2014 by Noel Daniel and entitled “A DEEPGAD Bitumen-Heavy Oil Recovery Process”.

### FIELD OF INVENTION

This invention relates to the recovery of oil from petroleum reservoirs, and relates particularly to the use of hydrogen peroxide and its aqueous solutions to recover viscous oils from various types of stratigraphic reservoirs. This further relates generally to a method of initiating an in situ reaction between the existing heavy oil or hydrocarbons and an injected oxidizer compound into a subterranean hydrocarbon-bearing formation. This invention relates more specifically to a process for mixing reagent fluids such as hydrogen peroxide together in a recovery well to generate heat therein via an exothermic reaction with the naturally occurring hydrocarbons. More particularly, the process is directed to carry the reactive fluids down separate flow paths from the earth's surface to the heavy oil (i.e. asphalt, tar) containing reservoirs via an injection well consisting of a stainless steel, slotted piping. The injection of the treatment fluids into the reservoir will reduce the viscosity and miscibility of the heavy oils thusly increasing flow of the targeted hydrocarbon through the subterranean zone via one or more horizontal or inclined well bores.

### BACKGROUND

### Field of Invention and Prior Art

### A. Introduction:

In excess of 4 trillion barrels of viscous oil are estimated to exist in Canada, Venezuela, Calif. and various other worldwide locations. Viscous oil may be defined as oil having a viscosity greater than about 100 centipoises at reservoir conditions. The known reserves of viscous oil are estimated to be at least three times the known worldwide reserves of easily recovered low viscosity oil. Much of the reserve is in tar sands. Tar sands are mined and processed to generate oil similar to oil pumped from conventional oil wells, but extracting oil from tar sands is more complex than conventional oil recovery. Oil sands recovery processes include extraction and separation systems to separate the bitumen from the clay, sand, and water that make up the tar sands. Bitumen also requires additional upgrading before it can be refined. Because it is so viscous (thick), it also requires dilution with lighter hydrocarbons to make it transportable by pipelines. Historically, Kentucky tar (bitumen) sands have been recognized and used as a mineral resource for more than 100 years. Asphalt or “tar sands” created boom towns with names such as Asphalt, Black Gold, Sweeden, and Kyrock as well as a trade name for road paving material Kentucky Rock (Kyrock for short). Kyrock material was marketed heavily by the Kentucky Rock Asphalt Company in the early 1900's and was used for paving many well-known places including Chicago, the Indianapolis 500 Motor Speedway, in Rio de Janeiro, Brazil, and Havana, Cuba. In the late 1950's, paving with asphalt was virtually discontinued with the advent of “ready mix” applications. With the DEEPGAD recovery process, asphalt can once again become a competitive and economically viable alternative for road pavement.

It is often desirable to heat a well penetrating an earth formation. For example, heat is often used to improve production from wells. In modern day production of hydrocarbons from subterranean formations, it is common practice to apply secondary recovery techniques to recover additional quantities of hydrocarbons. One of the more common secondary recovery techniques currently employed is that of in situ combustion. In this method of producing hydrocarbons, in situ combustion is initiated in the hydrocarbon-bearing formation near a well bore penetrating the formation and a combustion front is established. Once the formation has been successfully ignited, a combustion-supporting gas, e.g., an oxygen-containing gas such as compressed air, is injected into the well bore to support and drive the combustion front through the formation, thereby displacing the hydrocarbons in the formation toward a production well from which they are produced.

Successful ignition is generally dependent upon generating a temperature sufficient to support and propagate the combustion front. Among the techniques used for initiating the in situ combustion included in the prior art are various types of igniters such as downhole heaters, electrical heating devices and combustibles introduced into the well bore. Results from the utilization of many of these techniques have been less than satisfactory, primarily due to the fact that sufficiently high temperatures were not generated to ignite successfully the formation and establish a combustion front.

Heated fluid, such as steam, can also be injected into a subterranean formation to facilitate production of fluids from the formation. For example, steam may be used to reduce the viscosity of fluid resources in the formation so that the resources can more freely flow into the well bore and to the surface. Generally, steam generated for injection into a well requires large amounts of energy such as to compress and/or transport air, fuel, and water used to produce the steam. Much of this energy is largely lost to the environment without being harnessed in any useful way. Consequently, production of steam has large costs associated with its production.

### B. Problem Addressed:

With present technology, most of the world's high viscous (tar sands) oil reserves cannot be produced economically. The incentive to recover these vast reserves, however, is enormous and many methods have been tried to do so. Currently, oil is not produced from tar sands on a significant commercial level in the United States; in fact, only Canada has a large-scale commercial tar sands industry, though a small amount of oil from tar sands is produced commercially in Venezuela. Therefore, it is and has been an object to have a more economical process to recover bitumen and associated by-products from tar sands. The Genesis Energy, LLC DEEPGAD bitumen-heavy oil process addresses this problem for the oil industry. The term “DEEPGAD” is an anacronym for Deep Enhancement and Extraction Gravity Assisted Drainage.

Problems with many of the previous systems have been the presence of oxygen as a component of the hot gases being generated within the bitumen reservoir. Additionally, the hot oxygen component is capable of violently reacting with the carbon of the carbon steel in the tubing. Furthermore, dissolved oxygen in solution within the residual treatment fluid product presents severe corrosion problems. It is, therefore, another object of the present invention to inject into subterranean formations hot fluid mixtures with a reagent which render a reacting mixture that are substantially free of pure oxygen and essentially generated in limited quantities when the hydrogen peroxide begins its exothermic mixture with the organs present.

Concerns over surface tension of highly viscous bitumen-heavy solutions suggest the need for surfactants to assist in the reduction of the miscibility of reservoir fluids. In addition, the DEEPGAD recovery process uses surge pumps to further disrupt surface tension, reduce the miscibility, and enhance the effects of surfactants of the treatment fluid movement within the migratory flow pathway in the reservoir regimen.

### C. Prior Art:

Due to the viscous qualities of crude oil and capillary forces affecting the movement thereof, the recovery of oil from subterranean formations is incomplete and inefficient. Numerous efforts have been made to recover this residual crude oil, including the generation of hot gases and the use of heat from steam. The existing art for recovery of viscous oil includes the following methods.

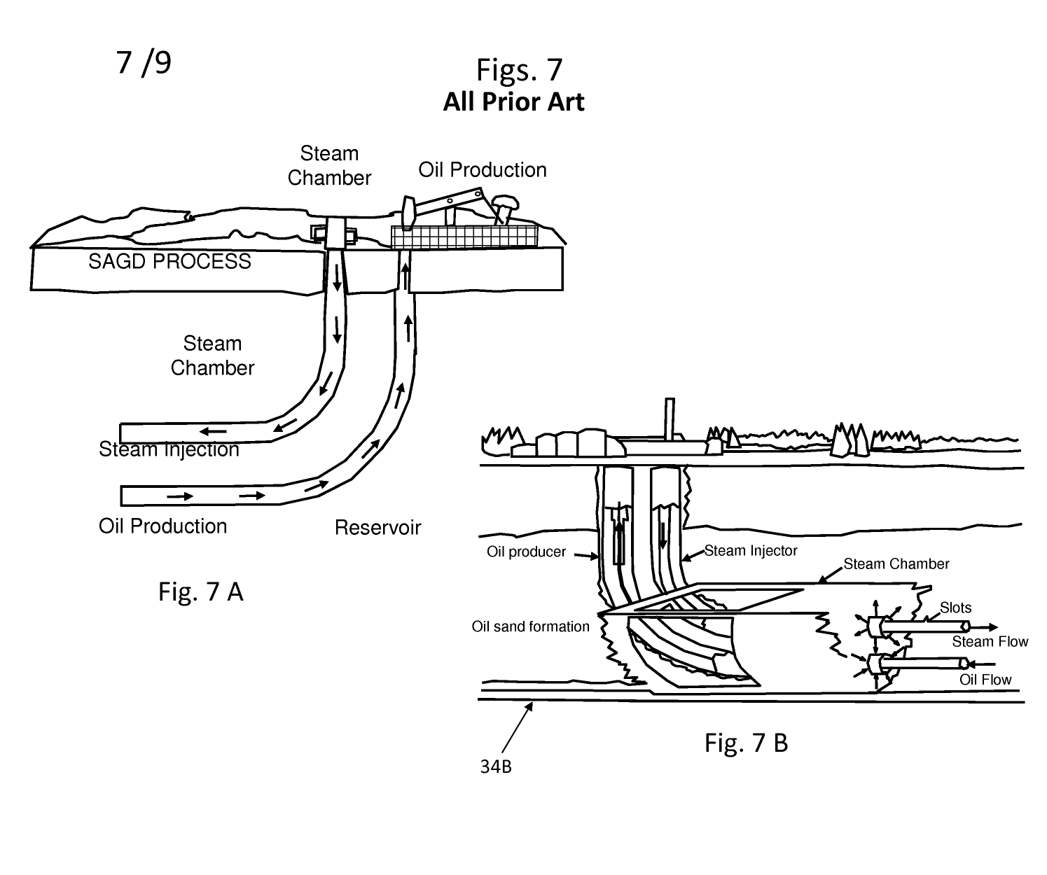

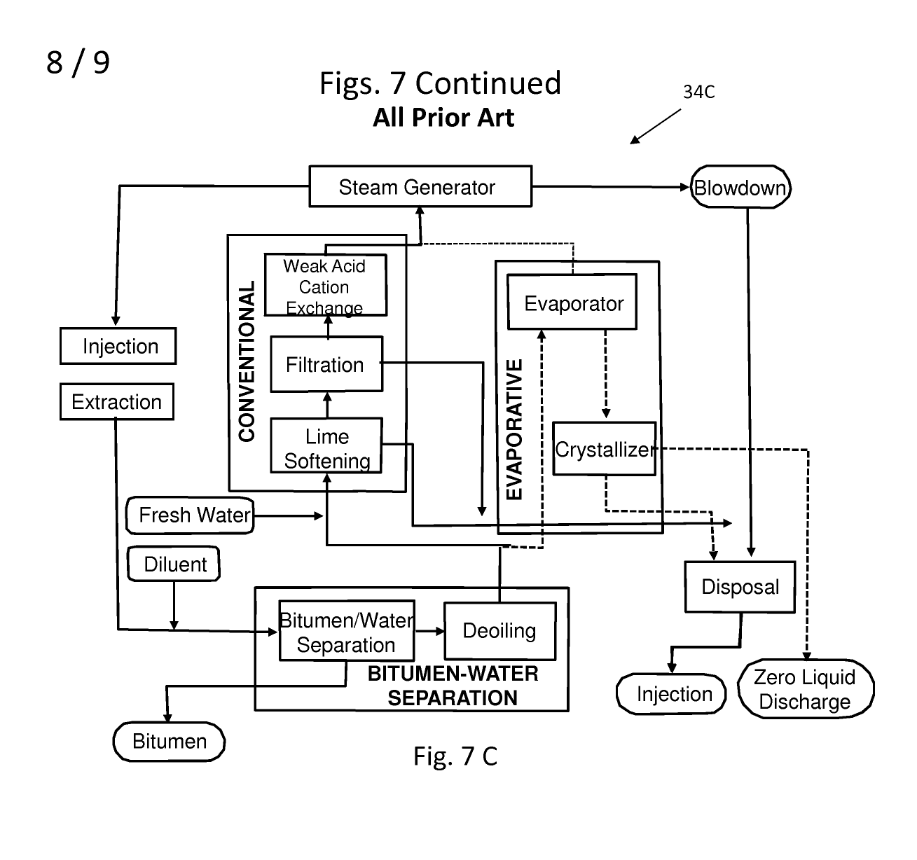

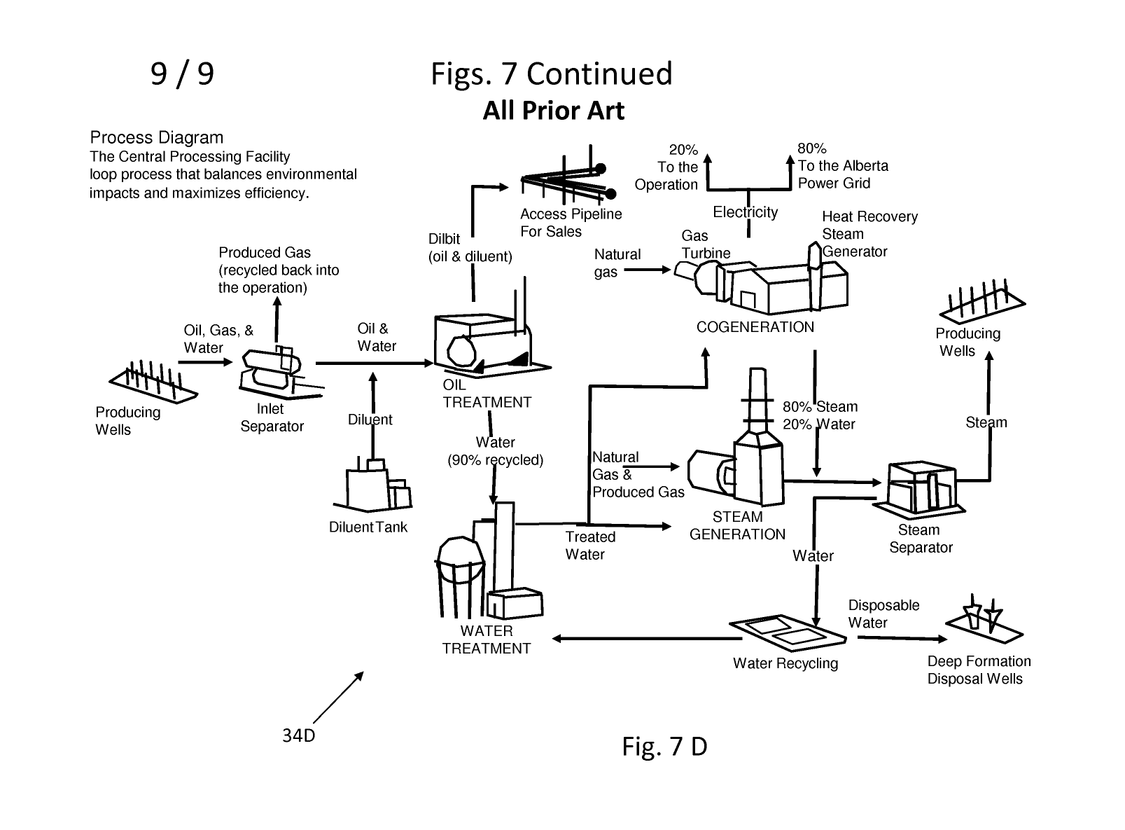

Most of the present recovery methods rely on thermal techniques to reduce the viscosity of the oil and increase its ability to flow. One method uses mining techniques to physically excavate the oil-containing sand in bulk and liberate the viscous oil from the sand by washing with hot water and solvents aboveground. Another method uses hot solvent to dissolve the viscous hydrocarbons from the mined tar sands. Perhaps the most commonly used non-mining thermal methods are: hot water injection, steam injection, and in situ combustion. These are generally shown in FIGS. 7A through 7D of the attached drawings.

(a) Hot Water Injection

The simplest thermal method to reduce oil viscosity in situ is by injection of hot water. The water is heated at the surface, and then pumped down a metallic casing into a subterranean oil-bearing formation. The hot water warms the oil thereby reducing its viscosity resulting in a less viscous oil that is able to migrate more freely toward the production recovery well. This method, however, is generally limited to relatively shallow reservoirs with significantly associated heat loss to the nonproductive overburden confining rock that effectively limits the lateral and horizontal maximum radial distance of the treatment fluids from the injection and recovery well sets.

(b) Steam Injection

Steam injection is generally preferred over hot water injection because, pound for pound, steam will typically have 3 to 4 times more heat available for reducing oil viscosity than will hot water. Typically, steam is generated at the surface and injected in much the same manner as hot water. Steam also loses heat to the nonproductive overburden (typically 10 to 30% of its heat content) but because of steam's higher initial heat content it can be used at greater depths to generate higher downhole temperatures than can hot water. The problems associated with steam injection are many and are well known to those skilled in the art. For instance, water treatment costs are high, and insulated injection tubing is required for deep reservoirs. Expensive and non-conventional completion methods must be used in steam injection, such as special cementing techniques, special expansion joints, special casing and couplings, etc. In addition, steam tends to inefficiently, selectively “finger” through the reservoir to the production well leaving large quantities of residual oil within the reservoir.

(c) In Situ Combustion

In order to reduce excessive heat losses to the nonproductive overburden during hot water or steam floods, techniques have been devised to generate the desired heat in the oil bearing zone itself. In situ combustion is one such method. Typically, air is compressed to some pressure higher than reservoir pressure and injected into the formation. Spontaneous ignition of the hydrocarbon with air can sometimes take place, but ways to initiate the combustion have also been suggested. For instance, L. S. Melik-Aslanov et al (Russian Patent Certificate No. 570700, Aug. 30, 1977) suggests use of chromic acid solution to catalyze the rapid decomposition of hydrogen peroxide at the bottom zone of a well bore. The rapid decomposition is theorized to cause a high temperature near the well bore which enhances recovery by initiating combustion of the resident oil during subsequent injection and ignition of air-water foam. Another method for causing a high temperature at the bottom of a well bore is suggested by J. C. McKimmell (U.S. Pat. No. 3,561,533). He proposed to mix foams of two highly reactive compounds in the well bore—hydrogen peroxide and hydrazine, a common rocket propellant mixture—to effect chemical heating in a well.

Other techniques to minimize the adverse effects of inert gas fingering have been used such as injection of pure oxygen or mixtures of oxygen with water, flue gas, or carbon dioxide. See, for example, W. R. Shu, U.S. Pat. Nos. 4,454,916 and 4,474,237, and G. Savard, U.S. Pat. No. 4,557,329. Manufacture and compression of pure oxygen in the oil field, however, is expensive and hazardous. More complete descriptions of the existing art may be found in Development of Heavy Oil Reservoirs, Briggs et al, J. of Petroleum Technology, February 1988, p. 206; and in the books Enhanced Oil Recovery of Residual and Heavy Oils, M. M. Schumacher, Second Ed., Noyes Data Corp., Park Ridge, N.J., ISBN 0-8155-0816-6, and Fundamentals of Enhanced Oil Recovery, H. K. van Poollen and Associates, PennWell Publishing, Tulsa 1980.

As far as known, there are no existing heavy oil recovery processes, or the like, compared with the DEEPGAD bitumen-heavy oil process presented here. It is believed that this DEEPGAD process is unique in its design and technologies.

### SUMMARY OF THE INVENTION

The present invention is directed to a process useful in mixing reagents in an injector well which subsequently react with bitumen-heavy petroleum products in or near the injector and recovery wells. As the reaction produces significant heat to the bitumen-heavy regions of the heavy oil reservoirs, the heat lowers the viscosity of the heavy oils and thus allows the more mobile material to be collected in a producer or recovery well. The recovery well is installed below it at a varying vertical distance depending on reservoir rock variable factors such as horizontal and vertical permeability, porosity, and micro-fracturing. The production/recovery well will also be attached to a vacuum pumping or pressure reduction system to assist or enhance the lateral flow rate of the treated/enhanced bitumen product.

This new DEEPGAD process may be simply described as: An in situ process, known as DEEPGAD, for efficiently upgrading and recovering highly viscous hydrocarbons resident in a geological subsurface formation. This DEEPGAD process is comprised of: Step (a) pre-mixing a reagent and carrier fluid at a predetermined concentration in an aqueous solution containment in an above-ground mix tank; Step (b) pumping by way of a surge or buster pump of the aqueous solution into the injector well; Step (c) depositing the aqueous solution sufficiently near resident hydrocarbon to produce heat, water, and oxygen in sufficient quantities to cause decomposing reaction with hydrocarbon to produce more heat, water and carbon dioxide; Step (d) injecting additional amounts of the aqueous solution into the formation at an injection location in sufficient quantity to continue the decomposing, to move the aqueous decomposition and reaction outwardly from the injection location, and to displace hydrocarbon within said formation; Step (e) recovering hydrocarbon in response to the decomposition of hydrogen peroxide in the formation and the production of heat, water and carbon dioxide whereby hot gaseous reaction produces significant heat and temperature rise and is substantially free of uncombined oxygen, thereby penetrating the hydrocarbon bearing formation and substantially lowering the highly viscous hydrocarbons which may then flow by gravity to and through at least one production well for a collection and a further processing at the surface. Alternatively, the preferred process wherein the carrier fluid is comprised of at least one surfactant and at least one inhibitor. A further enhancement is the process comprised further of Step (f) providing a vacuum to the production well so as to enhance the collection and recovery of the treated hydrocarbons in the at least one production well.

### Objects and Advantages

The Advantages and Benefits presented with the Deep Extraction and Enhanced Production Gravity Assisted Drainage process (DEEPGAD) are:

| Item | Advantages |
|---|---|
| 1 | is much less expensive |
| 2 | is more efficient and effective |
| 3 | is environmentally friendly |
| 4 | upgrades heavy bitumen oils within the |
| | reservoir to levels above 20° API Gravity |
| 5 | results in production of a higher quality |
| | product and will provide opportunities for |
| | increased production of vast worldwide |
| | bitumen deposits |

### DESCRIPTION OF THE DRAWINGS

### Figures

The accompanying drawings, which are incorporated in and constitute a part of this specification, illustrate an embodiment of the Deep Extraction and Enhanced Production Gravity Assisted Drainage process (DEEPGAD) that is preferred. The drawings together with the summary description given above and a detailed description given below serve to explain the principles of the DEEPGAD recovery process. It is understood, however, that the DEEPGAD recovery process is not limited to only the precise arrangements and instrumentalities shown.

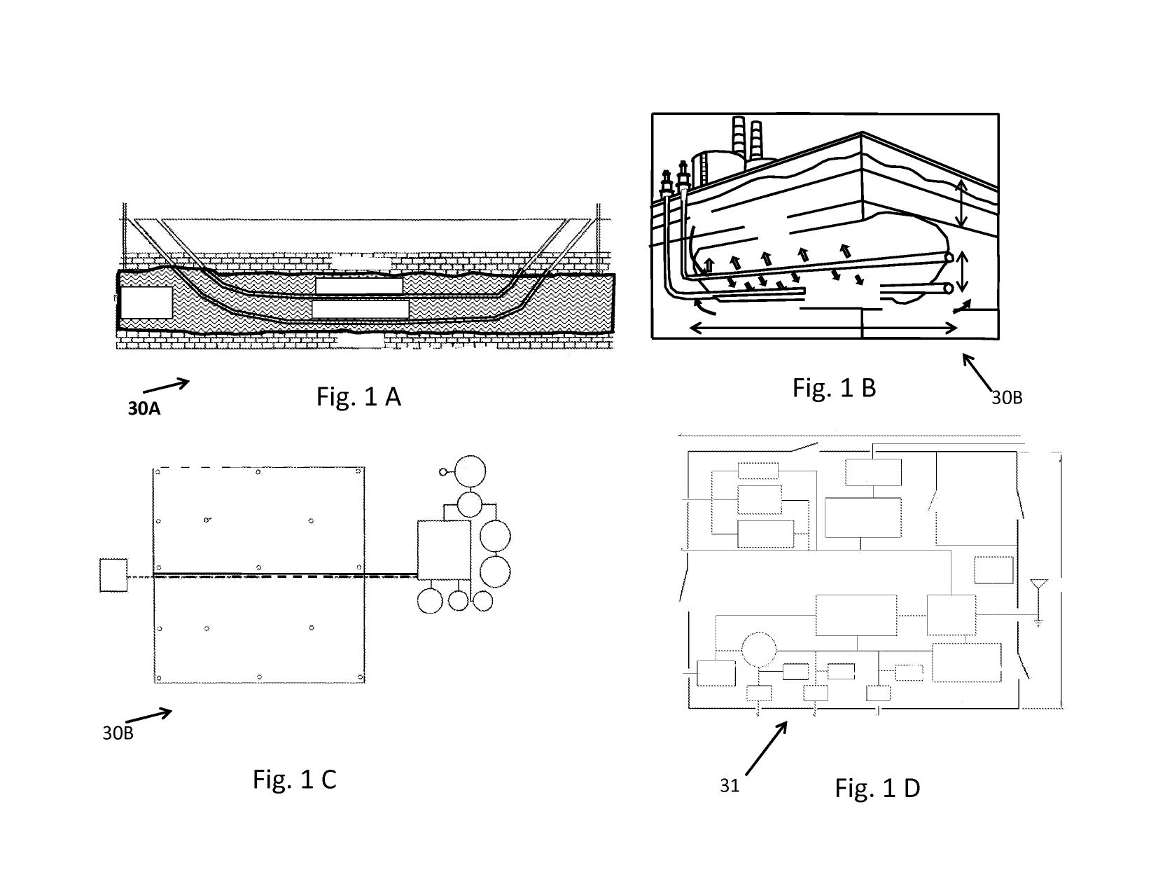

FIGS. 1A through 1D are the general DEEPGAD bitumen-heavy oil process cross-section; and isometric view of the process; a plan view, and a general control schematic of the DEEPGAD process.

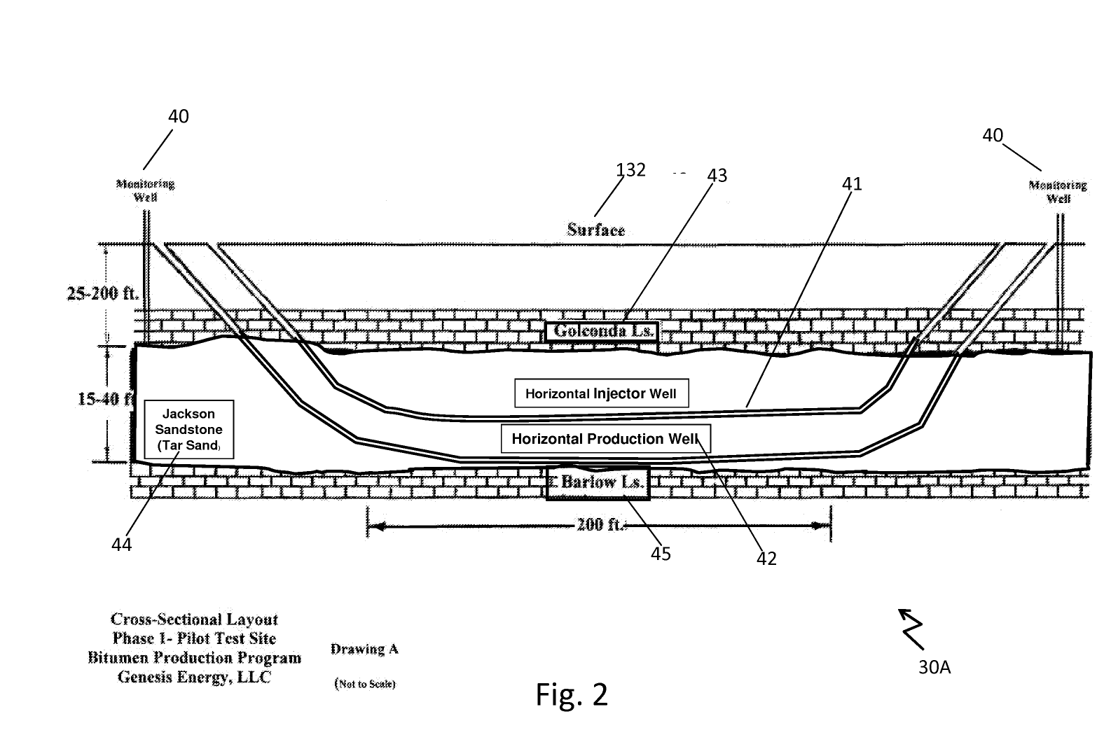

FIG. 2 is the general DEEPGAD bitumen-heavy oil process cross-section with components further described.

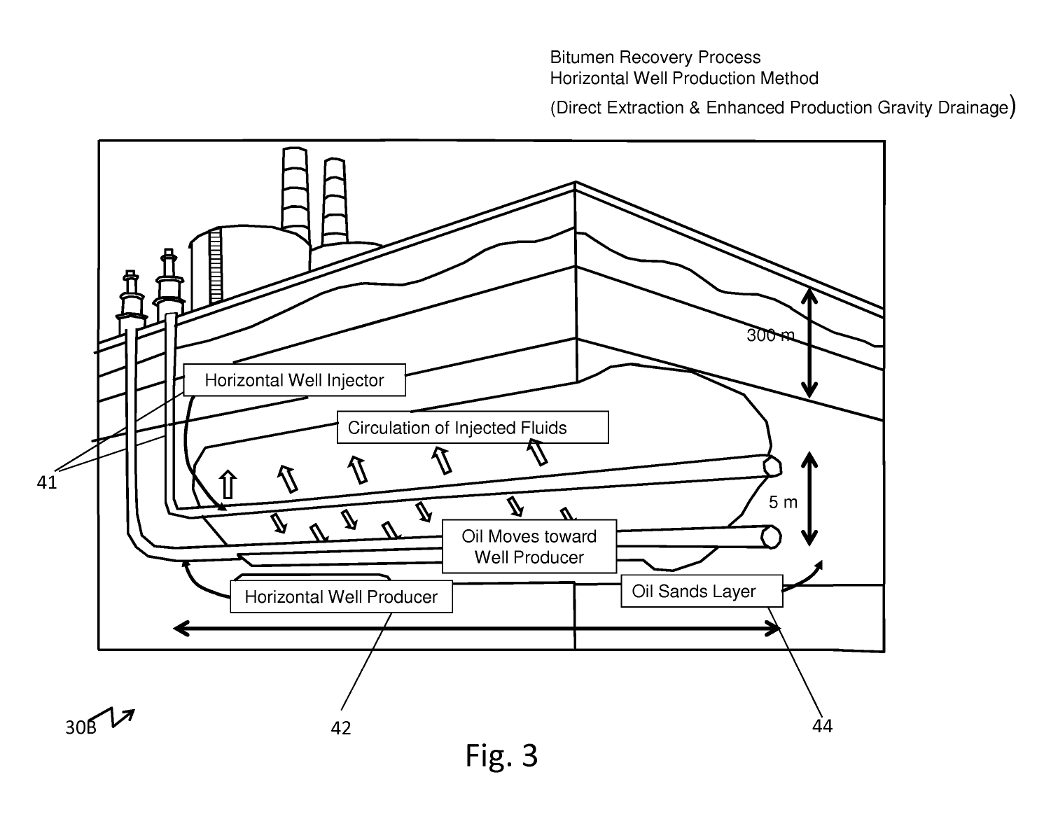

FIG. 3 is a general isometric of the DEEPGAD bitumen-heavy oil process with components further described.

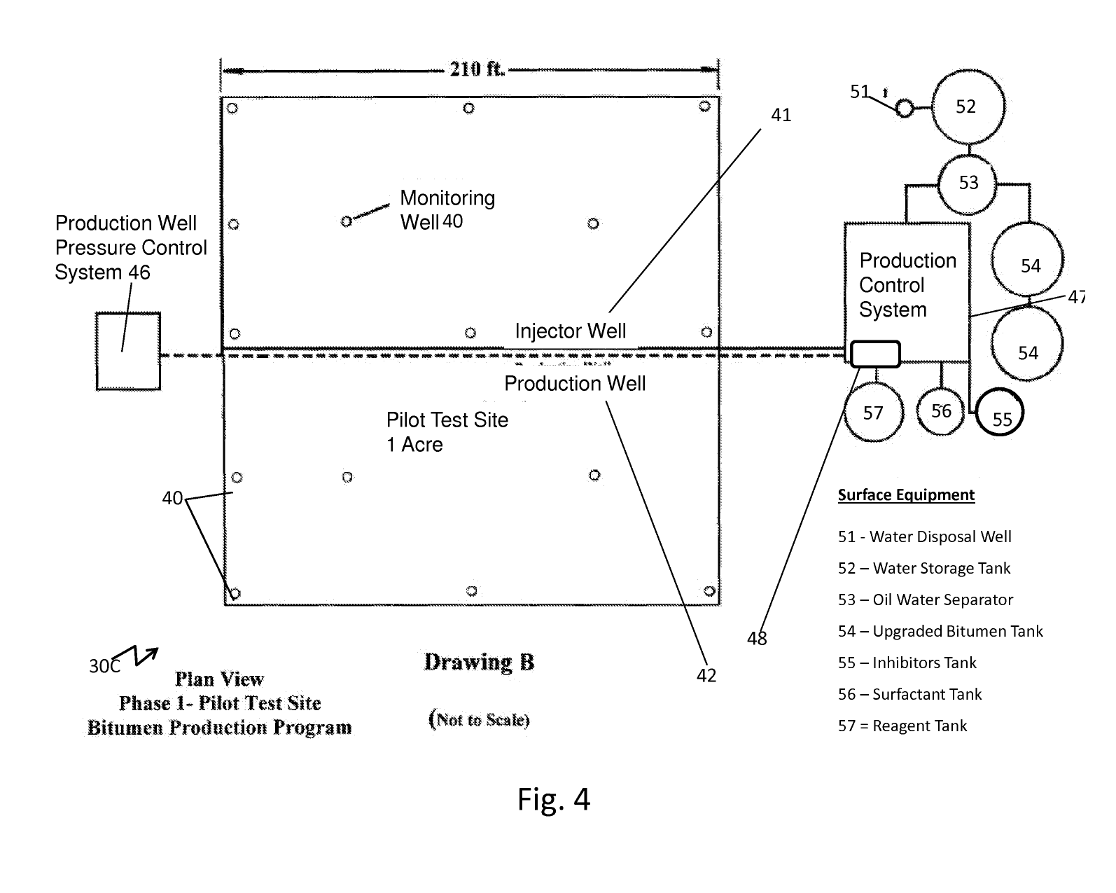

FIG. 4 is the plan view of an example layout for the DEEPGAD bitumen-heavy oil process with components further described.

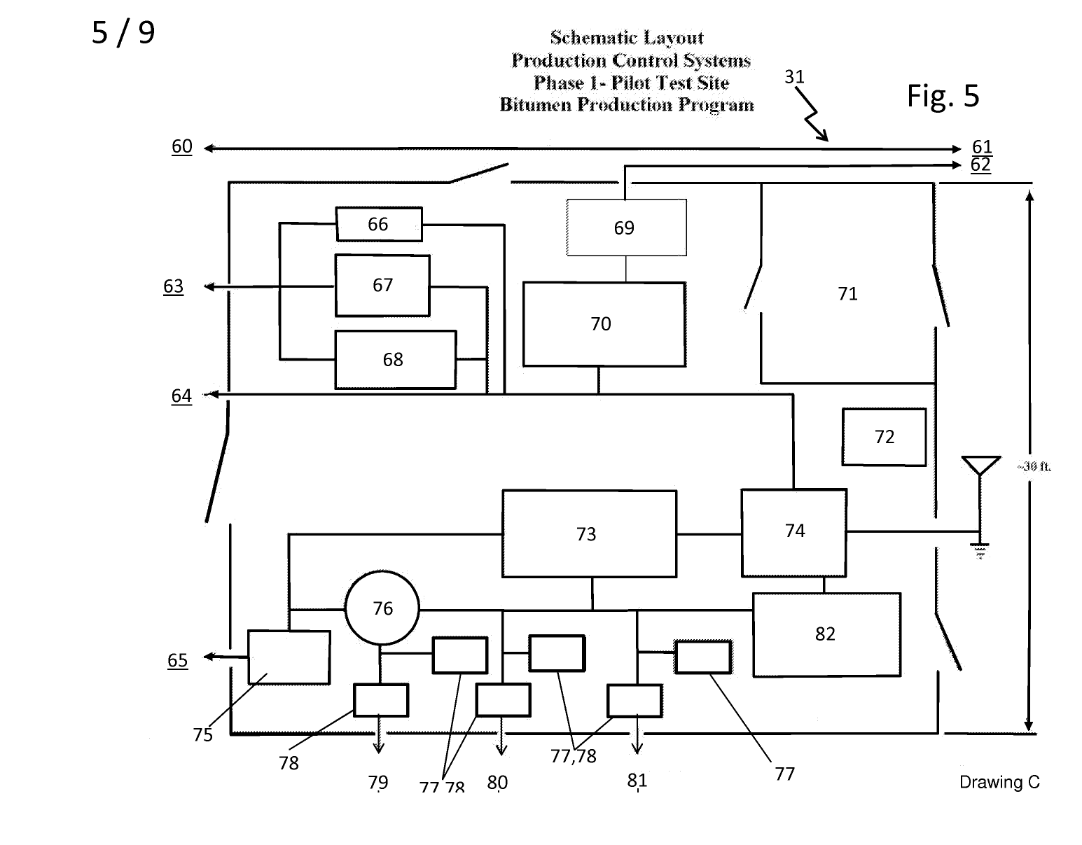

FIG. 5 is a schematic layout of the production control system for the DEEPGAD bitumen-heavy oil process with components further described.

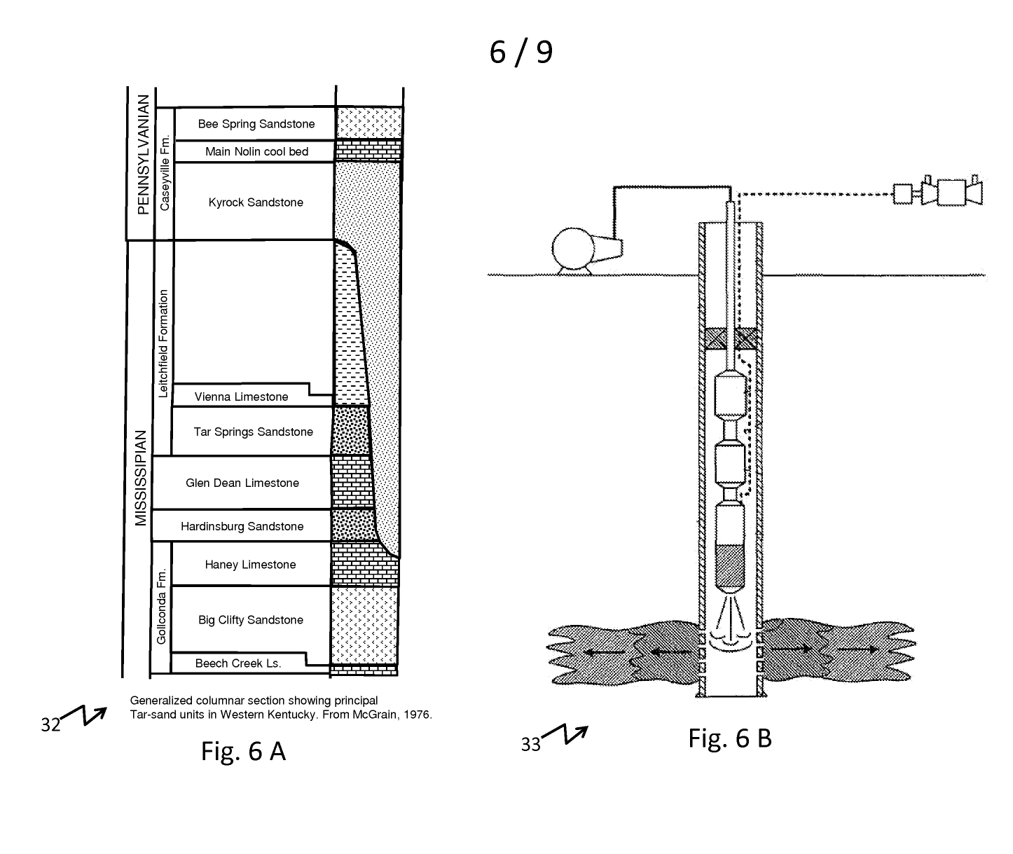

FIG. 6A is a typical geological cross section of a target site and FIG. 6B is a prior art depiction and description of a typical steam assisted gravity drainage process (SAGD) with components further described.

FIGS. 7A through 7D are examples of some prior art SAGD systems for general reference.

### DESCRIPTION OF THE DRAWINGS

### Reference Numerals

The following list refers to the drawings:

TABLE A
Reference numbers

| Ref # | Description |
|---|---|
| 30 | DEEPGAD bitumen-heavy oil process; Deep Extraction and |
| | Enhanced Production Gravity Assisted Drainage process |
| | (DEEPGAD); DEEPGAD recovery process 30 |
| 30A | DEEPGAD recovery process cross section 30A |
| 30B | DEEPGAD recovery process isometric view 30B |
| 30C | DEEPGAD recovery process plan layout view 30C |
| 31 | DEEPGAD production control system schematic layout 31 |
| 32 | typical geological cross section 32 |
| 33 | prior art depiction of a steam assisted gravity drainage |
| | process U.S. Pat. No. 8,235,118 using steam, reagent and |
| | fuel assist 32 |
| 34A | other prior art depictions a steam assisted gravity |
| through | drainage process 34A, 34B, 34C, and 34D |
| 34D | |
| 40 | monitoring well 40 |
| 41 | Horizontal Injector Well 41 |
| 42 | Horizontal Production Well 42 |
| 43 | Golconda Ls. - limestone 43 |
| 44 | Jackson Sandstone (Tar Sand) 44 |
| 45 | Barlow Ls. - limestone 45 |
| 46 | Production Well Pressure Control System 46 |
| 47 | Production Control Systems 47 |
| 48 | reciprocating or surge pump 48 or equal disruption means |
| | to inject reagent mixture of reagent and fluid (water or |
| | recycled water) into injector wells |
| 51 | Water Disposal Well 51 |
| 52 | Water Storage Tank 52 |
| 53 | 0il/Water Separator 53 |
| 54 | Upgraded Bitumen Product Tank 54 |
| 55 | Inhibitor Tank 55 |
| 56 | Surfactant Tank 56 |
| 57 | Reagent/reactor Tank 57 |
| 60 | from Production Well 60 |
| 61 | to Oil/Water Separator Unit 61 |
| 62 | to UIC Water Disposal Well 62 |
| 63 | to Production Well & Vacuum Pump 63 |
| 64 | to Monitoring Wells 64 |
| 65 | to Injector Well 65 |
| 66 | Vacuum Pump Control System 66 |
| 67 | Production Well Monitoring System 67 |
| 68 | Production Well Control Systems 68 |
| 69 | Waste Water UIC Well Control System 69 |
| 70 | Observation/Monitoring Wells Data Collection System 70 |
| 71 | Storage Area 71 |
| 72 | Auxiliary Power Generator 72 |
| 73 | Injector Well System Monitor & Computer Controls |
| | Equipment 73 |
| 74 | Systems Telemetry Equipment 74 |
| 75 | Surge Injection Pump Controller 75 |
| 76 | Mix Tank 76 |
| 77 | Flow Controller 77 |
| 78 | Pump 78 |
| 79 | To reagent Tank 79 |
| 80 | To surfactant Tank 80 |
| 81 | To Inhibitors Tank 81 |
| 82 | Process Control Center (Reagent/Surfactant/inhibitor) |
| | 82 |
| 100 | a downhole heated fluid generation system 100 |
| 102 | a compressor 102 |
| 104 | a pump 104 pumps a reactant or a reactant in solution |
| 106 | a working string 106 adapted for insertion into a well |
| | bore 126 |
| 108 | a fuel line 108 |
| 114 | a downhole reactor 114 |
| 116 | a packer 116 |
| 118 | a liquid/gas separator 118 |
| 122 | a combustor 122 |
| 124 | a casing 124 |
| 126 | a well bore 126 |
| 128 | perforations 128 |
| 130 | a subterranean zone 130 |
| 132 | the surface 132 |
| SAGD | steam assisted gravity drainage (SAGD) |
| DEEPGAD | Deep Extraction and Enhanced Production Gravity Assisted |
| | Drainage process (DEEPGAD) |

### DETAILED DESCRIPTION OF PREFERRED EMBODIMENT

The present development is a DEEPGAD bitumen-heavy oil treatment process. This invention relates to the recovery of oil from petroleum reservoirs and relates particularly to the use of hydrogen peroxide and its aqueous solutions to recover viscous oil from stratigraphic reservoirs. This further relates generally to a method of heating and initiating an in situ chemical reaction in a subterranean hydrocarbon-bearing formation. This invention relates more specifically to a process for mixing reagent fluids such as hydrogen peroxide together in a well to generate heat therein. More particularly, the process is directed to carry the reactive fluids down separate flow paths from the earth's surface to the lower end of a reaction section of the process slotted casing located in a drilled wellbore. For example, the heated fluid may be provided (e.g., injected) into a subterranean zone to reduce the viscosity of in-situ resources and increase the flow rate of the resources through the subterranean zone to one or more product recovery wells. The subterranean zone can include all or a portion of a resource bearing subterranean formation.

There is shown in FIGS. 1-7 a description and operative embodiment of the DEEPGAD bitumen-heavy oil process. In the drawings and illustrations, one notes well that the FIGS. 1-7 and sub figures demonstrate the general configuration and show examples but not limitations of DEEPGAD process. The various example uses are in the description and operation sections, below.

The accompanying drawings, which are incorporated in and constitute a part of this specification, illustrate an embodiment of the DEEPGAD bitumen-heavy oil process 30 that is preferred. The drawings together with the summary description given above and a detailed description given below serve to explain the principles of the DEEPGAD bitumen-heavy oil process 30. The DEEPGAD process (Deep Extraction, Enhanced Production with Gravity Assisted Drainage) is much less expensive, more efficient and effective, environmentally friendly, and upgrades heavy bitumen oils within the reservoir to levels above 20° API gravity. Phase 1 Pilot testing program will effectively result in the production of a higher quality product and open up the development of vast worldwide bitumen deposits.

FIGS. 1A through 1D are the general DEEPGAD bitumen-heavy oil process cross-section 30A; and isometric 30B of the process; a plan view 30C of the DEEPGAD process, and a general control schematic 31 of the DEEPGAD process. Components and further descriptions are shown below.

FIG. 2 is the general DEEPGAD bitumen-heavy oil process 30 cross-section 30A with components further described. Shown here are the components of the DEEPGAD recovery process cross section 30A including monitoring wells 40; at least one Horizontal Injector Well 41; at least one Horizontal Production Well 42; the Golconda Ls. —limestone 43 geological strata; the Jackson Sandstone (Tar Sand) 44 zone; the Barlow Ls. —limestone 45 strata; and the surface 132.

FIG. 3 is a general isometric 30B of the DEEPGAD bitumen-heavy oil process 30 with components further described. Demonstrated here are at least one Horizontal Injector Well 41; at least one Horizontal Production Well 42; and the Jackson Sandstone (Tar Sand) 44 zone. One notes that as the circulation fluids of the reagent mixture enters the oil sands layer 44, the bitumen-heavies temperature increase; the surfactant/peroxide injection and surge pump injected treatment fluid into the reservoir, will collectively reduce the bitumen viscosity. Fluid extracted from the reservoir will drain downward by gravity and migrate toward the production/recovery well(s) where it is extracted.

FIG. 4 is the plan view of an example layout 30C for the DEEPGAD bitumen-heavy oil process 30 with components further described. Demonstrated as one example and not limitation of a DEEPGAD recovery process plan layout view, 30C shows the following components: Production Well Pressure Control System 46; Production Control Systems 47; Water Disposal Well 51; Water Storage Tank 52; Oil/Water Separator 53; Upgraded Bitumen Product Tank 54; Inhibitor Tank 55; Surfactant Tank 56; reciprocating/surge pump; 48 or equal disruption means to inject reagent mixture of reagent and fluid (water or recycled water) into injector wells; and reagent/reactor Tank 57. Various reagents are considered. While hydrogen peroxide is the chief consideration, others are possible and part of the scope and basis of this invention. These include, for example and not limitation, Acetic acid—an organic acid; is one of the simplest carboxylic acids; Acetone—an organic compound; simplest example of the ketones; Acetylene—a hydrocarbon and the simplest alkyne; widely used as a fuel and chemical building block; Ammonia—inorganic; the precursor to most nitrogen-containing compounds; used to make fertilizer; Ammonium hydroxide—aqueous ammonia; used in traditional qualitative inorganic analysis; Azobisisobutyronitrile—organic compound; often used as a foamer in plastics and rubber and as a radical initiator; Baeyer's reagent—an alkaline solution of potassium permanganate; used in organic chemistry as a qualitative test for the presence of unsaturation, such as double bonds; N-Bromosuccinimide—a radical substitution and electrophilic addition reactions in organic chemistry; Butanone (methyl ethyl ketone)—organic compound; similar solvent properties to acetone but has a significantly slower evaporation rate; Butylated hydroxytoluene—a fat-soluble organic compound that is primarily used as an antioxidant food additive; n-Butyllithium—an organolithium reagent used as a polymerization initiator in the production of elastomers such as polybutadiene or styrene-butadiene-styrene (SBS); Carbon disulfide—a non-polar solvent; used frequently as a building block in organic chemistry; Carbon tetrachloride—a toxic, and its dissolving power is low; Carbonyldiimidazole—often used for the coupling of amino acids for peptide synthesis and as a reagent in organic synthesis; Ceric ammonium nitrate—an inorganic compound; used as an oxidising agent in organic synthesis and as a standard oxidant in quantitative analysis; Chloroform—organic compound; a precursor to teflon; Chromic acid—a strong and corrosive oxidising agent; an intermediate in chromium plating; Chromium trioxide—the acidic anhydride of chromic acid; mainly used in chrome-plating; Collins reagent—used to selectively oxidize primary alcohols to an aldehyde; Copper(I) iodide—useful in a variety of applications ranging from organic synthesis to cloud seeding; Dess-Martin periodinane—chemical reagent used to oxidize primary alcohols to aldehydes and secondary alcohols to ketones; Diborane—the central organic synthesis reagent for hydroboration; Dicyclohexylcarbodiimide—an organic compound; primary use is to couple amino acids during artificial peptide synthesis; Diethyl azodicarboxylate—a valuable reagent but also quite dangerous and explodes upon heating; Diethyl ether—organic compound; a common laboratory solvent; Dihydropyran—a heterocyclic compound; used as a protecting group for alcohols in organic synthesise; Diisobutylaluminium hydride—an organoaluminium compound; a reducing agent; converts esters and nitriles to aldehydes; Diisopropyl azodicarboxylate—the diisopropyl ester of azodicarboxylic acid; a reagent in the production of many organic compounds; Dimethyl ether—the simplest ether; a useful precursor to other organic compounds and an aerosol propellant; Dimethylformamide—organic compound; a common solvent for chemical reactions; Dimethylsulfide—organosulfur compound; used in petroleum refining and in petrochemical production processes; a reducing agent in ozonolysis reactions; Dimethyl sulfoxide—an organosulfur compound; an important polar aprotic solvent that dissolves both polar and nonpolar compounds; Dioxane—a heterocyclic organic compound; classified as an ether; Ethanol—a powerful psychoactive drug; used in alcoholic beverages, in thermometers, as a solvent, and as a fuel; Fehling's reagent—used to differentiate between water-soluble aldehyde and ketone functional groups; Fenton's reagent—a solution of hydrogen peroxide and an iron catalyst that is used to oxidize contaminants or waste waters; Formaldehyde—the simplest aldehyde; an important precursor to many other chemical compounds, such as polymers and polyfunctional alcohols; Formic acid—the simplest carboxylic acid; often used as a source of the hydride ion; Grignard reagents—the most common application is for alkylation of aldehydes and ketones; Hexamethylphosphoramide—a phosphoramide; useful polar aprotic solvent and additive in organic synthesis Hydrazine; Hydrazoic acid—used primarily for preservation of stock solutions, and as a reagent; Hydrochloric acid—a highly corrosive, strong mineral acid with many industrial uses; Hydrofluoric acid—valued source of fluorine, precursor to numerous pharmaceuticals; highly corrosive; Hydrogen peroxide—an oxidizer commonly used as a bleach; Imidazole—an organic compound; this aromatic heterocyclic is a diazole and is classified as an alkaloid; Isopropyl alcohol—simplest example of a secondary alcohol; dissolves a wide range of non-polar compounds; Lime—used in Flue Gas Desulphurisation in Power Plants; Limestone—used in Flue Gas Desulphurisation in Power Plants; Lithium aluminium hydride—a reducing agent in organic synthesis; used to prepare main group and transition metal hydrides from the corresponding metal halides; Lithium diisopropylamide—a strong base used in organic chemistry for the deprotonation of weakly acidic compounds; Manganese dioxide—used as a pigment and as a precursor to other manganese compounds; used as a reagent in organic synthesis for the oxidation of allylic alcohols; Meta-Chloroperoxybenzoic acid—used as an oxidant in organic synthesis; Methyl tert-butyl ether—a gasoline additive; also used in organic chemistry as a relatively inexpensive solvent; Millon's reagent—an analytical reagent used to detect the presence of soluble proteins; Nitric acid—highly corrosive and toxic strong acid; used for the production of fertilizers, production of explosives, and as a component of aqua regia; Osmium tetroxide—in organic synthesis, is widely used to oxidise alkenes to the vicinal diols; Oxalyl chloride—used in organic synthesis for the preparation of acid chlorides from the corresponding carboxylic acids; Palladium(II) acetate—a catalyst for many organic reactions by combining with many common classes of organic compounds to form reactive adduct; Perchloric acid—a powerful oxidizing agent; readily forms explosive mixtures; mainly used in the production of rocket fuel; Phosphoric acid—a mineral acid with many industrial uses; commonly used in the laboratory preparation of hydrogen halides; Phosphorus pentachloride—one of the most important phosphorus chlorides; a chlorinating reagent. Also used as a dehydrating agent for oximes which turn them into nitriles; Phosphorus tribromide—used for the conversion of alcohols to alkyl bromides; Phosphorus trichloride—most important of the three phosphorus chlorides; used to manufacture organophosphorus compounds; used to convert primary and secondary alcohols into alkyl chlorides, or carboxylic acids into acyl chlorides; Phosphoryl chloride—used to make phosphate esters such as tricresyl phosphate; Potassium dichromate—a common inorganic chemical reagent, most commonly used as an oxidizing agent in various laboratory and industrial applications; Potassium hydroxide—a strong base; precursor to most soft and liquid soaps as well as numerous potassium-containing chemicals; Potassium permanganate—a strong oxidizing agent; can be used to quantitatively determine the total oxidisable organic material in an aqueous sample; a reagent for the synthesis of organic compounds; Pyridinium chlorochromate—used to oxidize primary alcohols to aldehydes and secondary alcohols to ketones; Pyridinium dichromate (Cornforth reagent) and converts primary and secondary alcohols to ketone; Raney nickel—an alternative catalyst for the hydrogenation of vegetable oils; in organic synthesis, used for desulfurization; Samarium(II) iodide (Kagan Reagent)—a powerful reducing agent; Silver oxide—used to prepare other silver compounds; in organic chemistry, used as a mild oxidizing agent; Silver nitrate—precursor to many other silver compounds; commonly used in inorganic chemistry to abstract halides; Sodium amide—used in the industrial production of indigo, hydrazine, and sodium cyanide and used for the drying of ammonia; used as a strong base in organic chemistry; Sodium azide—gas-forming component in airbag systems; used in organic synthesis to introduce the azide functional group by displacement of halides; Sodium bis(trimethylsilyl)amide—a strong base; deprotonates ketones and esters to generate enolate derivative; Sodium borohydride—a versatile reducing agent; converts ketones and aldehydes to alcohols; Sodium chlorite—in organic synthesis, used for the oxidation of aldehydes to carboxylic acids; Sodium hydride—a strong base used in organic synthesis; Sodium hydroxide—strong base with many industrial uses; in the laboratory, used with acids to produce the corresponding salt, also used as an electrolyte; Sodium hypochlorite—frequently used as a disinfectant or a bleaching agent; Sodium nitrite—used to convert amines into diazo compounds; Sulfuric acid—strong mineral acid; major industrial use is the production of phosphoric acid; tert-Butyl hydroperoxide—used in a variety of oxidation processes; industrially, is used as a starter of radical polymerization; Tetrahydrofuran—one of the most polar ethers; a useful solvent; its main use is as a precursor to polymers; Tetrakis(triphenylphosphine)palladium(0)—a catalyst for palladium-catalyzed coupling reactions; Tetramethylammonium hydroxide and a quaternary ammonium salt; used as an anisotropic etchant of silicon; used as a basic solvent in the development of acidic photoresist in the photolithography process; Tetramethylsilane—the simplest tetraorganosilane; a building block in organometallic chemistry; Thionyl chloride—an inorganic compound; used in chlorination reactions; converts carboxylic acids to acyl chlorides; Thiophenol—an organosulfur compound; the simplest aromatic thiol; Titanium tetrachloride—an intermediate in the production of titanium metal and titanium dioxide; Tollens' reagent—a chemical test most commonly used to determine whether a known carbonyl-containing compound is an aldehyde or a ketone; and Triphenylphosphine.

FIG. 5 is a schematic layout 31 of the production control system for the DEEPGAD bitumen-heavy oil process 30 with components further described. Because this drawing is very operationally significant, it is described in the operation section, below.

FIG. 6 A is a typical geological cross section of a target bitumen recovery site. Shown here is an idealized geologic formation view of interest in Butler and Logan Counties, Kentucky containing the asphalt (bitumen) sand deposits in the Big Clifty Sandstone (also referred to as the Jackson Sandstone). The Big Clifty Sandstone is a Member of the Golconda Formation. This rock unit consists predominantly of a fine-medium grain sandstone with variable shale content. These sandstones were deposited during the Chester Series and are of late Mississippian Period in age. From the study of rock cores in the general region, geologists believe the bitumen containing sandstone was deposited in a near shore, shallow marine environment predominantly in barrier bar complexes. The Big Clifty sandstone outcrops a short distance to the south of the Genesis Energy leases. In the initial lease area, general thicknesses of the sandstone range from 15-37 feet as shown in the drawing. Major structural features in the area of interest consist of at least 4 normal faults related to the Pennyrile Fault System. Vertical displacement of the faults exceeds 100 feet with down-throw to the northwest in Butler County and to the southeast in Logan County. Importantly, the example of Jackson Sandstone, Big Clifty Sandstone and these Kentucky locations are exemplary and not limiting as to where the DEEPGAD Bitumen-Heavy Oil Recovery Process may be utilized.

FIG. 6B is a prior art depiction and description of a steam assisted gravity drainage process (SAGD) with components further described. Here is shown prior art depiction of a steam assisted gravity drainage process U.S. Pat. No. 8,235,118 using steam, surfactant, and fuel assist 32. One example of a downhole heated fluid generation system 100 is schematically depicted. The system 100 includes a working string 106 adapted for insertion into a well bore 126. The well bore 126 extends through a subterranean zone 130. The subterranean zone 130 is the zone that will be treated with heated fluid from the system 100. In this case, in SAGD, the heated fluid may be injected through one well bore and resources may be produced through one or more different well bores.

A casing 124 extends through the well bore 126 and into the subterranean zone 130, and includes apertures (e.g., perforations 128) in or near the zone 130. A number of different tools are provided in the working string 106 for the heated fluid treatment process, including a packer 116, a downhole reactor 114, a liquid/gas separator 118, and a combustor 122. The drawing depicts the packer 116 positioned to isolate the portion of the well bore 126 through the subterranean zone 130 from the remainder of the well bore 126. A pump 104 pumps a reactant or a reactant in solution downhole for use in generating the heated fluid. In certain instances, the pump 104 can reside at the surface 132. The working string 106 communicates the reactant to the downhole reactor 114. Additional compounds may be provided in the solution, for example, inhibitors, retarders, surfactant, etc. The downhole reactor 114 facilitates an exothermic reaction of the reactant. In certain instances, the downhole reactor 114 is a housing that carries a catalyst selected to facilitate the exothermic reaction on contact with the reactant. The heated water and/or steam and the oxygen are communicated from the downhole reactor 114 to the liquid/gas separator 118. The liquid/gas separator 118 operates to separate the gaseous oxygen from the heavier water and/or steam. Liquid/gas separator 118 is a cyclone separator.

A compressor 102 at the surface 132 operates to compress a source of fuel gas. A fuel line 108 external to the working string 106 communicates the compressed fuel gas to the downhole combustor 122. The compressed fuel gas and oxygen (and/or oxygen rich water) are combined and combusted in the downhole combustor 122. The heat generated by compressing the fuel gas carried by the fuel line 108 into the downhole combustor 122, and the heat from the exothermic decomposition carried by the oxygen, together with the pressure in the combustor 122 may be enough to initiate combustion in a catalytic combustor or a combustion chamber. To initiate combustion, the compounds can be combined downhole. The heated fluid is ejected from the downhole combustor 122 into the well bore 126, through the perforations 128 (if provided), and into the subterranean zone 130 to treat the subterranean zone 130.

With the DEEPGAD bitumen-heavy oil recovery process 30 by Genesis Energy, there are significant changes and improvements over the prior depicted art approach. The art described in the paragraphs above for the depiction of a steam assisted gravity drainage process U.S. Pat. No. 8,235,118 using steam, reagent and fuel assist 32 do not anticipate, nor deem obvious the following:
1. Genesis Energy injection/production wells using the Genesis Energy, LLC DEEPGRAD process are slanted to the surface and can be opened and accessed at both ends for cleanout, potential recovery from each end.
2. The fluid injection & treatment using the DEEPGAD process employs the use of reciprocating/surge/cavitation pumping in the injection wells. This approach increases effective lateral treatment area as a result of reducing surface tension or capillary action between upgraded bitumen products and reservoir regimen (rock).
3. DEEPGRAD production wells do not utilize downhole in situ “combustor units” to extend the effective reservoir treatment zone—rather rely on the in situ chemical reaction;
4. DEEPGRAD Production by-products, especially gaseous and vapor components, are captured/stored above-ground and selectively stored in a closed loop system;
5. DEEPGRAD process wastewater fluids are injected into UIC permitted injection wells drilled & completed into at deeper reservoirs depths below the bitumen production depths; these wells are licensed Underground Injection Control (UIC) wells and approved by the USEPA;
6. The prior art uses a combustor unit in downhole to create added heat. The DEEPGRAD treatment process does not need this more costly, extra complexity.
7. For the DEEPGRAD process system, the H2O2 per gallon per volume is significantly less costly cost of stream (35% Active/65% Water).
8. The DEEPGRAD process will generally produce reservoir fluid exothermically derived temperatures in the range of 400 to 450° F. [initial tests have demonstrated reservoir fluid temperatures of approximately 410° F.] vs. prior art steam temperatures of approximately 212° F.
9. The DEEPGRAD vacuum system will be installed on all production wells.
10. The DEEPGRAD system monitor wells maintain operational parameters on the bitumen reservoir including pressure, temperature, and provide sampling access to reservoir fluids.
11. The DEEPGRAD system injects the reagent fluids w/reciprocating cavitation/buster pumps which further disrupt surface tension of bitumen heavy product.
12. DEEPGRAD captures everything in the production well lines then separate off the oil, debris etc. for disposal and sell or dispose of the oil and gas product. DEEPGRAD injects residual materials to disposal wells.
13. DEEPGRAD injector & recovery wells can be installed by directional/conventional slant drilling equipment.
14. The DEEPGRAD system uses a closed loop system.
15. DEEPGRAD uses a stainless steel slotted piping for the product recovery wells. As plastic and composite pipe and tubing become more thermal resistant, it is anticipated some will also be capable of use in the DEEPGAD process.

FIGS. 7A through 7D are examples of some prior art SAGD systems for general reference. Perhaps the most commonly used non-mining thermal methods are: hot water injection, steam injection, and in situ combustion. These are generally shown in FIGS. 7A through 7D of the drawings. The sketches are self-explanatory to a person skilled in the prior arts of petroleum extraction and bitumen-heavy processing.

The details mentioned here are exemplary and not limiting. Other specific processes, methods, and manners specific to this DEEPGAD process (Deep Extraction, Enhanced Production with Gravity Assisted Drainage) may be somewhat similar to those found in traditional oil recovery methodologies as would be commonly expected.

### Operation of the Preferred Embodiment

The DEEPGAD bitumen-heavy oil process 30 has been described in the above embodiment. The manner of how the devices operate and attributes are described below. The process shown is preferred as: An in situ chemical reaction process, known as DEEPGAD, for efficiently recovering highly viscous hydrocarbons resident in a geological formation, which comprises: Step (a) pre-mixing a reagent and a carrier fluid at a predetermined concentration as an aqueous solution in a tank on a surface; Step (b) pumping by way of a reciprocating or surge pumping the aqueous solution into an injector well; Step (c) depositing the aqueous solution sufficiently near reservoir hydrocarbons to produce heat, water, and oxygen in sufficient quantities as to cause decomposing reaction with existing heavy oils to produce more heat, water and carbon dioxide; Step (d) injecting additional amounts of the aqueous solution into the formation at an injection location in sufficient quantity to continue the decomposing, to move the aqueous decomposition and reaction outwardly thru the reservoir from the injection location, and to displace the heavy hydrocarbons within said formation; Step (e) recovering hydrocarbon in response to the decomposition of hydrogen peroxide in the formation and the production of heat, water and carbon dioxide whereby hot gaseous reaction produces significant heat and temperature rise and is substantially free of uncombined oxygen, thereby penetrating the hydrocarbon bearing formation and substantially lowering the highly viscous hydrocarbons which may then flow by gravity to and through at least one production well for a collection and a further processing at the surface. Alternatively, the preferred process wherein the carrier fluid is comprised of at least one or more surfactants and at least one FE inhibitor. A further enhancement is the process comprised further of Step (f) providing a partial vacuum on the reservoir via injection into the injector well to enhance the collection of the highly viscous hydrocarbons in the at least one production well.

FIG. 2 is the general DEEPGAD bitumen-heavy oil process cross-section referred to as the Deep Enhanced Extraction Process Gravity Assisted Drainage (DEEPGAD) method. This process has an important advantage over the commonly used SAGD recovery method. The SAGD method injects large quantities of steam into the bitumen rock via horizontal injector wells. While the method is successful, it requires large volumes of fresh water to produce steam. Our DEEPGAD method does not use steam and fresh water. DEEPGAD bitumen-heavy oil process is, therefore, less expensive. Furthermore, this method enhances the extracted bitumen quality resulting in a more valuable market product in an environmentally friendly manner. Traditional SAGD bitumen production utilizes a two shallow horizontal well set to inject steam into the sand/carbonate reservoir. The horizontal injector well is commonly drilled and completed approximately 15-20 feet above the underlying and parallel receptor or collector well. Steam heated bitumen flows by gravity into the collector well and pumped to the shallow surfaces. The DEEPGAD oil process approach is similar except (1) the wells are considerably less expensive to drill and complete since they are drilled using less expensive methods other than traditional vertical drill equipment at shallower depths and (2) the wells will result in an extracted/enhanced in situ (in place) bitumen-based product with a lower viscosity, higher API market grade, and increased value. More specifically, with the DEEPGAD process, lower costs are incurred to (i) gain access to and prepare well locations for drilling, including surveying well locations for the purpose of determining specific development drilling sites, clearing/preparing the drill pad site, draining, road building, and relocating public roads, gas pipelines, and power lines, to the extent necessary, in developing the proved reserves, (ii) drill and equip development wells, development-type stratigraphic test wells and service wells, including the costs of platforms and of well equipment such as casing, tubing, pumping equipment, and the wellhead assembly, (iii) acquire, construct and install, production facilities such as leases, flow lines, separators, treaters, heaters, manifolds, measuring devices and production storage tanks, natural gas cycling and processing plants, and central utility and waste disposal systems, and (iv) provide improved recovery systems. Some process cost indicators are:
Average depths in the typical lease area 15-30 ft.
Average porosity typically 15-16%
Average permeabilities run typically ˜10-400 millidarcies
Oil saturation 40-70 percent
Oil gravity essentially 8-10° API
   This is substantiated with the example from the Jackson sandstone bitumen reservoir—the initial process target-which has an average thickness of 15 feet with depths ranging 15-100 feet the bitumen reservoir rock porosity averages 16%.

FIG. 3 is a general isometric 30B of the DEEPGAD bitumen-heavy oil process 30 with components further described. Demonstrated here are at least one Horizontal Injector Well 41; at least one Horizontal Production Well 42; and the exemplary Jackson Sandstone (Tar Sand) reservoir 44 zone. One notes that as the circulation fluids of the reagent mixture enters the oil sands layer 44, the bitumen-heavies start to warm up and the surfactant, Fe inhibitor, surge pumping actions (“huff and puff” method), and higher reservoir temperatures reduce the viscosity of the heavy oil laden petroleum, with the help of gravity drainage, increasing gas pressures, and partial reservoir vacuum maintenance, migrates toward the production well(s) where it is extracted.

FIG. 4 is the plan view of an example layout for the DEEPGAD bitumen-heavy oil recovery process with components further described. From the description above, one skilled in the art of process controls will appreciate that the production control center of the DEEPGAD recovery process 30 anticipates that the center 47 will control the injection flow of the reagent mixture to the injector well 41 by use of the reciprocating/surge pumps (or equal); the mixture percentage of reagent from tanks 57 to the fluid (such as water) from tanks 52 or fresh; the additional quantities/amounts and flow mix rates of the surfactant(s)/inhibitor from tanks 56 and inhibitor(s) from tanks 55 to the reagent mixture; and the injection pressure of the pumps. Likewise the production control center 47 will manage/control the oil/water/gas separator rate 53 and discharge to the water disposal well 51; the filling, exchange and emptying of the upgraded bitumen product tanks 54, and communicate with the production well pressure control system 46 (likely at the opposite end of the production well(s) 42. Finally the production well pressure control system anticipates one or more vacuum systems (such as controlled pumps or equal) to assist the extraction of the bitumen oil, water, gas and fines/particulate matter which will flow to the separator and tank areas for initial processing and preparation for delivery to the next processing step and point of sale.

FIG. 5 is a schematic layout 31 of the production control system for the DEEPGAD bitumen-heavy oil recovery process with components further described. The schematic 31 generally shows the exchange of information and data (i.e. communication to/from) required to control the injection and 41 production wells 42 by the production control system 47. Here is an illustration of one example. The schematic is intended to be exemplary and not limited to the control of the overall DEEPGAD bitumen-heavy oil recovery process 30. Shown here are: DEEPGAD production control system schematic layout 31 with communication from Production Well 60; to oil/water separator unit 61, to UIC Water Disposal Well 62; to the Production Well & Vacuum Pump 63; to Monitoring Wells 64 to Injector Well 65; Vacuum Pump Control System 66; Production Well Monitoring System 67; Production Well Control Systems 68; Waste Water UIC Well Control System 69; Observation/Monitoring Wells, Data Collection System 70; Storage Area 71; Auxiliary Power Generator 72; Injector Well System Monitor and Computer Controls Equipment 73; Systems Telemetry Equipment 74; Surge Injection Pump Controller 75; Mix Tank 76; Flow Controller 77; Pump 78; To reagent Tank 79 To surfactant Tank 80; To Inhibitors Tank 81; and Process Control Center (Reagent/Surfactant/inhibitor) 82. One, skilled in the art of process controls, especially with petroleum process and recovery, appreciates well the exchange of a plethora of data such as pressure (positive and vacuum), flow data, temperature levels, tank levels, viscosity, chemical pH reading—acid/alkalinity, and the like, necessary to holistically control the DEEPGAD bitumen-heavy oil recovery process.

With this description it should be understood that the DEEPGAD bitumen-heavy oil recovery process 30 is not to be limited to only the disclosed embodiment of product. The features of the DEEPGAD bitumen-heavy oil recovery process 30 are intended to cover various modifications and equivalent arrangements included within the spirit and scope of the description.

Unless defined otherwise, all technical and scientific terms used herein have the same meaning as commonly understood by one of ordinary skills in the art to which these inventions belong. Although any methods and materials similar or equivalent to those described herein can also be used in the practice or testing of the present inventions, the preferred methods and materials are now described. All patents and publications mentioned herein, including those cited in the background of the application, are hereby incorporated by reference to disclose and described the methods and/or materials in connection with which the publications are cited.

The publications discussed herein are provided solely for their disclosure prior to the filing date of the present application. Nothing herein is to be construed as an admission that the present inventions are not entitled to antedate such publication by virtue of prior invention. Further, the dates of publication provided may be different from the actual publication dates which may need to be independently confirmed.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

Thus the scope of this invention should be determined by the appended claims and their legal equivalents. Therefore, it will be appreciated that the scope of the present invention fully encompasses other embodiments which may become obvious to those skilled in the art and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention for it to be encompassed by the present claims. Furthermore, no element, component, or method step in the present disclosure is intended to be dedicated to the public regardless of whether the element, component, or method step is explicitly recited in the claims.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

As used herein, spatial or directional terms, such as “left,” “right,” “front,” “back,” and the like, relate to the subject matter as it is shown in the drawing FIGS. However, it is to be understood that the subject matter described herein may assume various alternative orientations and, accordingly, such terms are not to be considered as limiting. Furthermore, as used herein (i.e., in the claims and the specification), articles such as “the,” “a,” and “an” can connote the singular or plural. Also, as used herein, the word “or” when used without a preceding “either” (or other similar language indicating that “or” is unequivocally meant to be exclusive—e.g., only one of x or y, etc.) shall be interpreted to be inclusive (e.g., “x or y” means one or both x or y). Likewise, as used herein, the term “and/or” shall also be interpreted to be inclusive (e.g., “x and/or y” means one or both x or y). In situations where “and/or” or “or” are used as a conjunction for a group of three or more items, the group should be interpreted to include one item alone, all of the items together, or any combination or number of the items. Moreover, terms used in the specification and claims such as have, having, include, and including should be construed to be synonymous with the terms comprise and comprising.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

What is claimed is:

1. An in situ chemical reaction process, known as DEEPGAD, for efficiently recovering highly viscous hydrocarbons resident in a geological formation which comprises:
Step (a) pre-mixing a reagent types and a carrier fluid at a predetermined concentration as an aqueous solution in a tank on a surface;
Step (b) pumping by way of a ddddd pump types reciprocating/surge or buster pump the aqueous solution into an injector well;
Step (c) depositing the aqueous solution sufficiently near resident hydrocarbon to produce heat, water and oxygen in sufficient quantities to cause a decomposing reaction with hydrocarbon(s) to produce more heat, water and carbon dioxide;
Step (d) injecting additional amounts of the aqueous solution into the formation at an injection location in sufficient quantity to continue the decomposition, to move the aqueous decomposition and reaction outwardly from the injection location, and to displace hydrocarbon within said geologic formation;
Step (e) recovering hydrocarbons list markush in response to the decomposition of hydrogen peroxide in the geologic formation and the production of heat, water and carbon dioxide whereby hot, gaseous reaction produces significant heat and temperature rise and is substantially free of uncombined oxygen, thereby penetrating the hydrocarbon bearing formation and substantially lowering the viscosity of the resident hydrocarbons which may then flow by gravity to and through at least one production well for collection and further processing at the surface facility.

2. The process in claim 1 wherein the carrier fluid is comprised of at least one surfactant and at least one inhibitor.

3. The process in claim 1 further comprised of:
Step (f) providing a partial vacuum to the production well to enhance the collection of the highly viscous hydrocarbons in at least one production well.

4. The process in claim 1 wherein the reagent types is from the group consisting of hydrogen peroxide; Acetic acid; Acetone; Ammonia; Ammonium hydroxide; Carbon disulfide; Copper(I) iodide; Diethyl ether; Dimethyl ether; Ethanol; Formaldehyde; Formic acid; Hydrazoic acid; Hydrochloric acid; Hydrofluoric acid; Isopropyl alcohol; Lime; Limestone; Nitric acid; Perchloric acid; Phosphoric acid; Phosphorus pentachloride; Phosphoryl chloride; Potassium dichromate; Potassium hydroxide; Potassium permanganate; Silver nitrate; Sodium amide; Sodium chlorite; Sodium hydride; Sodium hydroxide; Sodium hypochlorite; Sodium nitrite; and Sulfuric acid

5. The process in claim 1 wherein the pump used is from a group consisting of a reciprocating pump, surge pump and buster pump.

6. The process in claim 1 wherein the piping used is from a group consisting of a stainless steel slotted piping for the product recovery wells; slotted plastic and slotted composite pipe and tubing.
